(19) United States
(12) Patent Application Publication
(10) Pub. No.: US 2025/0129803 A1
(43) Pub. Date: Apr. 24, 2025

(54) VACUUM PRODUCTION DEVICE WITH DUAL-FUNCTION CONTROL SPOOL AND HANDLING DEVICE COMPRISING SUCH A VACUUM PRODUCTION DEVICE

(71) Applicant: COVAL, MONTELIER (FR)

(72) Inventor: Loïc JOGUET, MONTELIER (FR)

(21) Appl. No.: 18/920,564

(22) Filed: Oct. 18, 2024

(30) Foreign Application Priority Data
Oct. 19, 2023 (FR) 2311336

(51) Int. Cl. F15B 13/04; F15B 13/043

(52) U.S. Cl. CPC F15B 13/0402; F15B 13/043

(57) ABSTRACT

A vacuum production device includes at least a first ejector having an inlet port and a suction port. The device includes a control member that includes a body having at least one pressure inlet and one suction inlet intended to be connected respectively to a pressurised air circuit and to a vacuum circuit, and a first spool mounted so as to be able to move in the body between a connection position in which the inlet port of the first ejector is connected to the pressure inlet and the suction port of the first ejector is connected to the suction inlet, and a disconnection position in which the inlet port of the first ejector is disconnected from the pressure inlet and the suction port of the first ejector is disconnected from the suction inlet. A handling device includes such a vacuum production device.

The present invention relates to the field of pneumatic circuits and, more particularly, the control of vacuum circuits for gripping and handling parts by vacuum.

### BACKGROUND OF THE INVENTION

Devices for producing vacuum on the basis of ejection are known. Such a device comprises an ejector that comprises an air inlet nozzle and an air outlet venturi that are separated from one another by an intermediate chamber communicating with the outside via a suction port. The inlet nozzle of the ejector is connected to a pressurised air circuit by means of a control valve and the air suction port is often fitted with a control valve or a poppet. The air introduced into the inlet nozzle via an inlet port is accelerated in the venturi, creating a vacuum in the intermediate chamber and in the vacuum circuit via the suction port.

Some devices comprise several ejectors with venturis of different profiles so that vacuum production can be adapted according to requirements. The ejectors are then each controlled by a valve and connected to the vacuum circuit by poppets in order to prevent leaks between the ejectors. The resulting space requirement and complexity, including in terms of control, make it difficult to incorporate these vacuum production devices into the machines they are intended to equip, in particular if the application in question requires the machine to be relatively compact.

### OBJECT OF THE INVENTION

The aim of the invention is, in particular, to provide a multi-ejector vacuum production device that is relatively simple and compact.

### SUMMARY OF THE INVENTION

To this end, according to the invention, a vacuum production device is provided, comprising at least a first ejector having an inlet port and a suction port, a second ejector having an inlet port and a suction port, a control member that comprises a body having at least one pressure inlet and one suction inlet intended to be connected respectively to a pressurised air circuit and to a vacuum circuit, a first spool mounted so as to be able to move in the body between a connection position in which the inlet port of the first ejector is connected to the pressure inlet and the suction port of the first ejector is connected to the suction inlet, and a disconnection position in which the inlet port of the first ejector is disconnected from the pressure inlet and the suction port of the first ejector is disconnected from the suction inlet, and a second spool mounted so as to be able to move in the body between a connection position in which the inlet port of the second ejector is connected to the pressure inlet and the suction port of the second ejector is connected to the suction inlet, and a disconnection position in which the inlet port of the second ejector is disconnected from the pressure inlet and the suction port of the second ejector is disconnected from the suction inlet.

The control member therefore able, using a single spool, for each ejector, to simultaneously connect the ejector to the pressure circuit and to the vacuum circuit and to simultaneously disconnect the ejector from the pressure circuit and the vacuum circuit. This results in simpler control implemented by a single, relatively compact control member.

According to one particular embodiment, the body comprises a first pressure channel and a first vacuum channel separated from each other and respectively provided with a first seat and a second seat extending in line with each other along a sliding axis along which the first spool slides between its connection position and its disconnection position. The first pressure channel extends from the inlet port of the first ejector to the pressure inlet and the first vacuum channel extends from the suction port of the first ejector to the suction inlet. The first spool passes through the first pressure channel and the first vacuum channel and comprises a first poppet for cooperating with the first seat and a second poppet for cooperating with the second seat. The first poppet and the second poppet are engaged with the first seat and the second seat when the first spool is in its disconnection position, the first poppet and the second poppet being separated from the first seat and the second seat when the first spool is in its connection position.

Advantageously, the body comprises a second pressure channel and a second vacuum channel separated from each other and respectively provided with a first seat and a second seat extending in line with each other along a sliding axis along which the second spool slides.

According to another particular embodiment, the first spool and the second spool form a single spool received in a chamber provided with at least one pressure opening connected to the pressure inlet and a primary vacuum opening connected to the suction inlet, a first outlet opening connected to the inlet port of the first ejector, a second outlet opening connected to the inlet port of the second ejector, a first secondary vacuum opening connected to the suction port of the first ejector, a second secondary vacuum opening connected to the suction port of the second ejector. The single spool is able to move between a first position and a second position and comprises:
a first pressure passage and a first vacuum passage for respectively connecting the pressure opening to the first outlet opening and the primary vacuum opening to the first secondary vacuum opening when the first spool is in its first position; the first spool being arranged so that, in its second position, it disconnects the pressure opening from the first outlet opening and the primary vacuum opening from the first secondary vacuum opening; and
a second pressure passage and a second vacuum passage for respectively connecting the pressure opening to the second outlet opening and the primary vacuum opening to the second secondary vacuum opening when the spool is in its second position; the first spool being arranged so that, in its first position, it disconnects the pressure opening from the second outlet opening and the primary vacuum opening from the second secondary vacuum opening.

Advantageously, in this other embodiment, the chamber comprises two primary vacuum openings, i.e., a first primary vacuum opening connected to the first secondary vacuum opening by the first vacuum passage when the single spool is in its first position, and a second primary vacuum opening connected to the second secondary vacuum opening by the second vacuum passage when the single spool is in its second position.

Preferably, the single spool is arranged to have an intermediate position in which it disconnects:
the pressure opening from the first outlet opening and the primary vacuum opening from the first secondary vacuum opening; and
the pressure opening from the second outlet opening and the primary vacuum opening from the second secondary vacuum opening.

According to optional features, used individually or fully or partly in combination:
the device comprises at least one resilient return element mounted between the single spool and the body to resiliently return the single spool towards its intermediate position;
the device comprises at least one resilient return element mounted between the first spool and/or the second spool and the body to resiliently return the first spool and/or the second spool towards its connection position;
the control member comprises an actuator for moving the first spool and/or the second spool at least towards its disconnection position; and
the pressure inlet of the control member is connected to the pressurised air circuit by a proportional valve.

The invention also relates to a handling device comprising a gripper having a duct connected to the suction inlet of such a vacuum production device.

Other features and advantages of the invention will become apparent on reading the following description of particular and non-limiting embodiments of the invention.

### BRIEF DESCRIPTION OF THE DRAWINGS

Reference will be made to the accompanying drawings, in which:

FIG. 1 is a schematic cross-sectional view of a vacuum production device according to a first embodiment of the invention;

FIG. 2 is a schematic cross-sectional view of a vacuum production device according to a second embodiment of the invention;

FIG. 3 is more detailed view, in cross section as in FIG. 2, of the vacuum production device according to the second embodiment of the invention;

FIG. 4 is a view similar to FIG. 3, showing this same device during use;

FIG. 5 is a view similar to FIG. 3 of the vacuum production device according to a first variant of the second embodiment of the invention; and

FIG. 6 is a view similar to FIG. 3 of the vacuum production device according to a second variant of the second embodiment of the invention.

### DETAILED DESCRIPTION OF THE INVENTION

The invention is described in this instance in application to the generation of a vacuum in a handling gripper. The vacuum production device according to the invention is intended to be connected to a pressurised air circuit 101 and to a vacuum circuit 102 of the gripper.

In reference to the figures, the device in this instance comprises a first ejector 1.1 and a second ejector 1.2. It is understood that the device could comprise a single ejector or more than two ejectors.

Each ejector 1.1, 1.2 comprises a nozzle 2.1, 2.2 and an air outlet venturi 3.1, 3.2 which are separated from one another by an intermediate chamber 4.1, 4.2. The nozzle 2.1, 2.2 comprises an air inlet port 5.1, 5.2 and the intermediate chamber communicates with the outside via a suction port 6.1, 6.2. When air is introduced under pressure into the inlet nozzle 2.1, 2.2 via the inlet port 5.1, 5.2, it is accelerated in the venturi 3.1, 3.2, creating a vacuum in the intermediate chamber 4.1, 4.2 and in the vacuum circuit via the suction port 6.1, 6.2. This venturi 3.1 has a different profile to that of the venturi 3.2, and the first ejector 1.1 and the second ejector 1.2 therefore offer different vacuum production performances.

The device comprises a control member 10 for connecting the ejectors 1.1, 1.2 to the pressurised air circuit 101 and to the vacuum circuit 102.

The control member 10 comprises a body 11 having at least one pressure inlet 12 and one suction inlet 13 intended to be connected respectively to the pressurised air circuit 101 and to the vacuum circuit 102. The pressure inlet 12 of the control member 10 is in this instance connected to the pressurised air circuit 101 by a proportional solenoid valve 70 for adjusting the air flow rate as required.

At least one spool is mounted so as to be able to move in the body 11 between two positions so as to selectively connect one or the other of the ejectors to the pressurised air circuit 101 and to the vacuum circuit 102. The principle of the invention is that a single spool is arranged so that:
in a connection position, it connects the inlet port 5.1 (or 5.2) to the pressure inlet 12 and the suction port 6.1 (or 6.2) to the suction inlet 13; and
in a disconnection position, it disconnects the inlet port 5.1 (or 5.2) from the pressure inlet 12 and the suction port 6.1 (or 6.2) from the suction inlet 13.

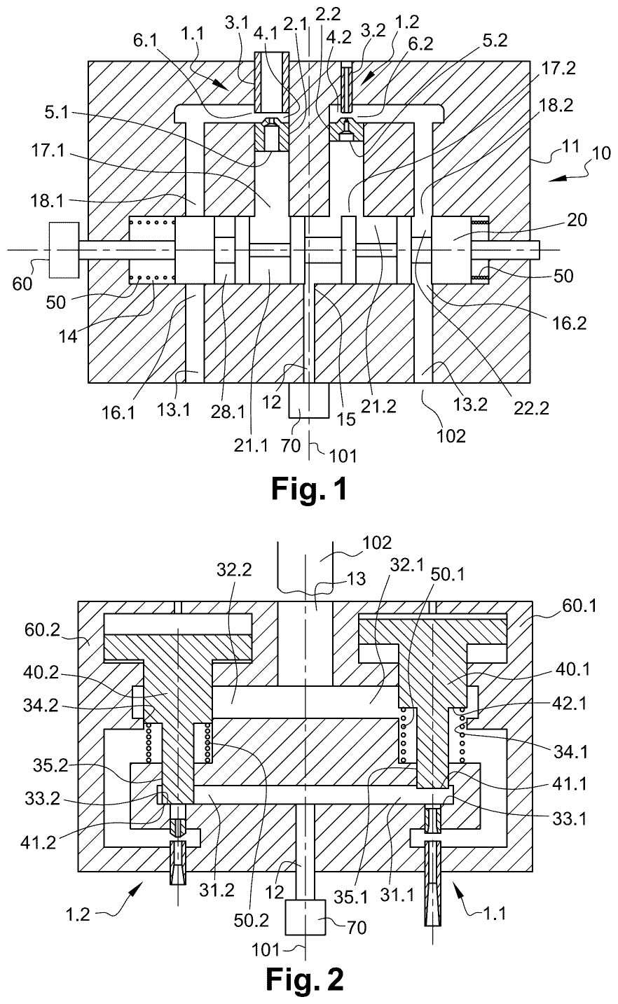

The first embodiment of the invention will now be described in relation to FIG. 1.

In this first embodiment, the control member 10 comprises only a single spool 20 that is mounted so as to slide in a chamber 14 of the body 11. The body comprises a single pressure inlet 12 and two suction inlets 13.1, 13.2. As a variant, the two suction inlets 13.1, 13.2 may be connected to each other. The chamber 14 is provided with:
a pressure opening 15 connected to the pressure inlet 12;
a first primary vacuum opening 16.1 connected to the first suction inlet 13.1;
a second primary vacuum opening 16.2 connected to the first suction inlet 13.2;
a first outlet opening 17.1 connected to the inlet port 5.1 of the first ejector 1.1;
a second outlet opening 17.2 connected to the inlet port 5.2 of the second ejector 1.2;
a first secondary vacuum opening 18.1 connected to the suction port 6.1 of the first ejector 1.1; and
a second secondary vacuum opening 18.2 connected to the suction port 6.2 of the second ejector 1.2.
   The spool 20 comprises:
a first pressure passage 21.1 and a first vacuum passage 22.1; and
a second pressure passage 21.2 and a second vacuum passage 22.2.

The spool 20 is able to move in the chamber 14 between a first end position and a second end position.

In the first end position:
the first pressure passage 21.1 and the first vacuum passage 22.1 respectively connect the pressure opening 15 to the first outlet opening 17.1 and the first primary vacuum opening 16.1 to the first secondary vacuum opening 18.1; and
the spool 20 is arranged to disconnect the pressure opening 15 from the second outlet opening 17.2 and the primary vacuum opening 16.2 from the second secondary vacuum opening 18.2.

The first end position is therefore both a connection position connecting the first ejector 1.1 to the circuits 101, 102 and a disconnection position disconnecting the second ejector 1.2 from the circuits 101, 102.

In the second end position:
the second pressure passage 21.2 and the second vacuum passage 22.2 respectively connect the pressure opening 15 to the second outlet opening 17.2 and the second primary vacuum opening 16.2 to the second secondary vacuum opening 18.2; and
the spool 20 is arranged to disconnect the pressure opening 15 from the first outlet opening 17.1 and the first primary vacuum opening 16.1 from the first secondary vacuum opening 18.1.

The second end position is therefore both a connection position connecting the second ejector 1.2 to the circuits 101, 102 and a disconnection position disconnecting the first ejector 1.1 from the circuits 101, 102.

The spool 20 is in this instance arranged to have an intermediate position in which it disconnects:
the pressure opening 15 from the first outlet opening 17.1 and the first primary vacuum opening 16.1 from the first secondary vacuum opening 18.1; and
the pressure opening 15 from the second outlet opening 17.2 and the second primary vacuum opening 16.2 from the second secondary vacuum opening 18.2.

It should be understood that, when spool 20 is in the intermediate position, the pressure opening 15 is closed and none of the ejectors 1.1, 1.2 is supplied or produces vacuum.

The control member 10 comprises two resilient elements 50 mounted between the spool 20 and the body 11, acting against each other along the direction in which the spool slides, in order to resiliently return the spool 20 towards its intermediate position. The intermediate position, or neutral position, may be used to regulate the vacuum level or provide a blowing action if there is a valve connected to the vacuum circuit 102 in order to connect a compressed air supply source.

The spool 20 is in this instance moved between its two end positions by an actuator 60 such as a pneumatic jack controlled by a solenoid valve or a linear electrical actuator. The actuator 60 is controlled in a manner that is known per se, for example by a microcontroller connected to a pressure sensor arranged in the vacuum circuit 102.

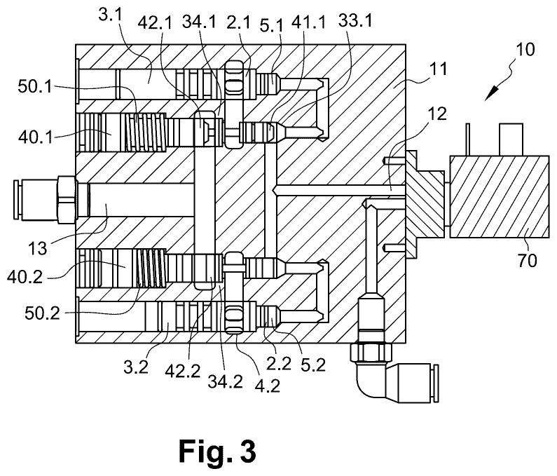

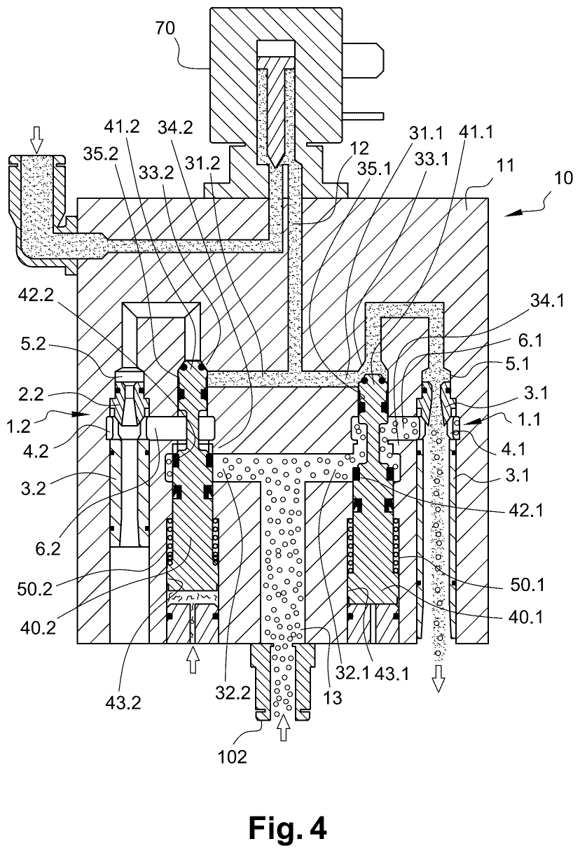

The second embodiment of the invention will now be described in relation to FIGS. 2 to 6.

In this second embodiment, the device comprises two spools 40.1, 40.2 that are each able to move between the connection position and the disconnection position in order to control the ejector 1.1 and the ejector 1.2 respectively.

The body 11 of the control member 10 comprises a first pressure channel 31.1 and a first vacuum channel 32.1 separated from each other and respectively provided with a first seat 33.1 and a second seat 34.1 extending in line with each other along a sliding axis along which the first spool 40.1 slides between its connection position and its disconnection position. The first pressure channel 31.1 extends from the inlet port 5.1 of the first ejector 1.1 to the pressure inlet 12 and the first vacuum channel 32.1 extends from the suction port 6.1 of the first ejector 1.1 to the suction inlet 13.

The first spool 40.1 passes through the first pressure channel 31.1 and the first vacuum channel 32.1 and comprises a first poppet 41.1 for cooperating with the first seat 33.1 and a second poppet 42.1 for cooperating with the second seat 34.1. Therefore, the first poppet 41.1 and the second poppet 42.1 are engaged with the first seat 33.1 and the second seat 34.1 when the first spool 40.1 is in its disconnection position, and the first poppet 41.1 and the second poppet 42.1 are separated from the first seat 33.1 and the second seat 34.1 when the first spool 40.1 is in its connection position. It can be seen in FIG. 2 that the body 1 comprises a bore 35.1 extending along the direction in which the first spool 40.1 slides and bringing the first pressure channel 31.1 and the first vacuum channel 32.1 into communication. This bore is provided with means for providing a tight seal with the first spool 40.1 such that the first spool 40.1 slides there in a sealed manner to prevent a pressure leakage from the first pressure channel 31.1 to the first vacuum channel 32.1.

The body 11 of the control member 10 comprises a second pressure channel 31.2 and a second vacuum channel 32.2 separated from each other and respectively provided with a first seat 33.2 and a second seat 34.2 extending in line with each other along a sliding axis along which the second spool 40.2 slides between its connection position and its disconnection position. The second pressure channel 31.2 extends from the inlet port 5.2 of the second ejector 1.2 to the pressure inlet 12 and the second vacuum channel 32.2 extends from the suction port 6.1 of the second ejector 1.2 to the suction inlet 13.

The second spool 40.2 passes through the second pressure channel 31.2 and the second vacuum channel 32.2 and comprises a first poppet 41.2 for cooperating with the first seat 33.2 and a second poppet 42.2 for cooperating with the second seat 34.2. Therefore, the first poppet 41.2 and the second poppet 42.2 are engaged with the first seat 33.2 and the second seat 34.2 when the second spool 40.2 is in its disconnection position, and the first poppet 41.2 and the second poppet 42.2 are separated from the first seat 33.2 and the second seat 34.2 when the second spool 40.2 is in its connection position. It can be seen in FIG. 2 that the body 1 comprises a bore 35.2 extending along the direction in which the second spool 40.2 slides and bringing the second pressure channel 31.2 and the first vacuum channel 32.2 into communication. This bore is provided with means for providing a tight seal with the second spool 40.2 such that the second spool 40.2 slides there in a sealed manner to prevent a pressure leakage from the second pressure channel 31.2 to the second vacuum channel 32.2.

The spools 40.1, 40.2 have, on the side opposite the first poppet 41.1, 41.2, an end part forming a piston, received in a sealed sliding manner in a housing 43.1, 43.2 of the body 11 to define two chambers there having volumes which are variable in opposition to each other, i.e., a cylindrical rear chamber and an annular front chamber extending around said end part forming a piston. A port connecting to a control valve leads into the rear chamber.

According to the second embodiment, as shown in FIGS. 2 to 4, the control member 10 comprises a first resilient return element 50.1 mounted between the first spool 40.1 and the body 11 to resiliently return the first spool 40.1 towards its connection position and a second resilient return element 50.2 mounted between the second spool 40.2 and the body 11 to resiliently return the second spool 40.2 towards its connection position.

The control member 10 comprises an actuator for moving each spool 40.1, 40.2 towards its disconnection position against the force exerted by the resilient return element 50.1, 50.2. The actuator is in this instance a pneumatic jack 60.1, 60.2 having a piston to which the spool 40.1, 40.2 is secured.

It should be understood that, with the second embodiment, it is possible to simultaneously use the two ejectors 1.1, 1.2, whereas this is not possible with the first embodiment.

It should also be understood that, owing to the position of the resilient return elements 50.1, 50.2 (which in this case are simple coil springs), the control device is normally open: if the air supply is cut off, the spools 40.1, 40.2 are resiliently returned to the disconnection position, venting the ejectors 1.1, 1.2 and interrupting the production of vacuum.

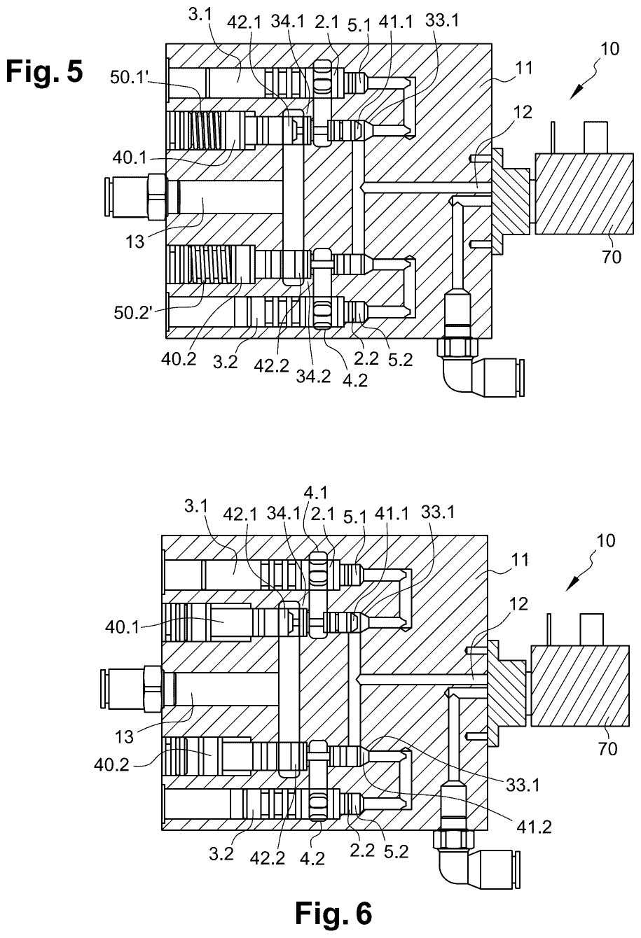

According to the first variant of the second embodiment, shown in FIG. 5, the control member 10 comprises a first resilient return element 50.1′ mounted between the first spool 40.1 and the body 11 to resiliently return the first spool 40.1 towards its disconnection position and a second resilient return element 50.2′ mounted between the second spool 40.2 and the body 11 to resiliently return the second spool 40.2 towards its disconnection position.

It should be understood that, owing to the position of the resilient return elements 50.1′, 50.2′ (which in this case are also simple coil springs), the control device is normally closed: if the air supply is cut off, the spools 40.1, 40.2 are resiliently returned to the connection position such that the control member 10 maintains the vacuum in the network.

According to the second variant of the second embodiment, shown in FIG. 6, the control member 10 does not have a resilient element returning the spools 40.1, 40.2 to one or other of their positions.

It should be understood that, owing to the lack of resilient return elements, the spools 40.1, 40.2 remain in their position if the air supply is cut off. The lack of resilient return elements has the advantage of allowing equal times of movement of the spools between their two positions, irrespective of the direction of movement (the resilient return elements 50.1, 50.2, 50.1′, 50.2′ counter the movement of the spool in one direction and promote the movement of the spool in the opposing direction).

Naturally, the invention is not limited to the described embodiments, but covers any variant that falls within the scope of the invention as defined by the claims.

In particular, the control member 10 may have a different structure to that described and shown here.

The body may comprise more than one pressure opening connected to the pressure inlet 12 and more or fewer than two primary vacuum openings.

The body may comprise more than one pressure inlet 12 and more or fewer than two suction inlets 13.1, 13.2.

The injectors may comprise one or more venturi stages.

The suction inlet of the vacuum production device may be connected to a gripper (the part of the handling device in contact with the object to be handled), a box, a suction cup or any other apparatus operating with a vacuum.

The device may or may not comprise resilient members for returning the pistons.

1. A vacuum production device, comprising at least a first ejector having an inlet port and a suction port, a second ejector having an inlet port and a suction port, a control member that comprises a body having at least one pressure inlet and one suction inlet intended to be connected respectively to a pressurised air circuit and to a vacuum circuit, a first spool mounted so as to be able to move in the body between a connection position in which the inlet port of the first ejector is connected to the pressure inlet and the suction port of the first ejector is connected to the suction inlet, and a disconnection position in which the inlet port of the first ejector is disconnected from the pressure inlet and the suction port of the first ejector is disconnected from the suction inlet, and a second spool mounted so as to be able to move in the body between a connection position in which the inlet port of the second ejector is connected to the pressure inlet and the suction port of the second ejector is connected to the suction inlet, and a disconnection position in which the inlet port of the second ejector is disconnected from the pressure inlet and the suction port of the second ejector is disconnected from the suction inlet.

2. The vacuum production device according to claim 1, wherein the body comprises a first pressure channel and a first vacuum channel separated from each other and respectively provided with a first seat and a second seat extending in line with each other along a sliding axis along which the first spool slides between its connection position and its disconnection position, the first pressure channel extending from the inlet port of the first ejector to the pressure inlet and the first vacuum channel extending from the suction port of the first ejector to the suction inlet, the first spool passing through the first pressure channel and the first vacuum channel and comprising a first poppet for cooperating with the first seat and a second poppet for cooperating with the second seat, the first poppet and the second poppet being engaged with the first seat and the second seat when the first spool is in its disconnection position, the first poppet and the second poppet being separated from the first seat and the second seat when the first spool is in its connection position.

3. The vacuum production device according to claim 2, wherein the body comprises a second pressure channel and a second vacuum channel separated from each other and respectively provided with a first seat and a second seat extending in line with each other along a sliding axis along which the second spool slides.

4. The vacuum production device according to claim 1, the first spool and the second spool forming a single spool received in a chamber provided with at least one pressure opening connected to the pressure inlet and a primary vacuum opening connected to the suction inlet, a first outlet opening connected to the inlet port of the first ejector, a second outlet opening connected to the inlet port of the second ejector, a first secondary vacuum opening connected to the suction port of the first ejector, a second secondary vacuum opening connected to the suction port of the second ejector, the single spool being able to move between a first position and a second position and comprising:
a first pressure passage and a first vacuum passage for respectively connecting the pressure opening to the first outlet opening and the primary vacuum opening to the first secondary vacuum opening when the first spool is in its first position; the first spool being arranged so that, in its second position, it disconnects the pressure opening from the first outlet opening and the primary vacuum opening from the first secondary vacuum opening; and
a second pressure passage and a second vacuum passage for respectively connecting the pressure opening to the second outlet opening and the primary vacuum opening to the second secondary vacuum opening when the spool is in its second position; the first spool being arranged so that, in its first position, it disconnects the pressure opening from the second outlet opening and the primary vacuum opening from the second secondary vacuum opening.

5. The vacuum production device according to claim 4, wherein the chamber comprises two primary vacuum openings, i.e. a first primary vacuum opening connected to the first secondary vacuum opening by the first vacuum passage when the single spool is in its first position and a second primary vacuum opening connected to the second secondary vacuum opening by the second vacuum passage when the single spool is in its second position.

6. The vacuum production device according to claim 5, wherein the single spool is arranged to have an intermediate position in which it disconnects:
the pressure opening from the first outlet opening and the primary vacuum opening from the first secondary vacuum opening; and
the pressure opening from the second outlet opening and the primary vacuum opening from the second secondary vacuum opening.

7. The vacuum production device according to claim 6, comprising at least one resilient return element mounted between the single spool and the body to resiliently return the single spool towards its intermediate position.

8. The vacuum production device according to claim 1, comprising at least one resilient return element mounted between the first spool and/or second spool and the body to resiliently return the first spool and/or second spool towards its connection position.

9. The vacuum production device according to claim 1, wherein the control member comprises an actuator for moving the first spool and/or second spool at least towards its disconnection position.

10. The vacuum production device according to claim 1, wherein the pressure inlet of the control member is connected to the pressurised air circuit by a proportional valve.

11. A handling device comprising a gripper having a duct connected to the suction inlet of a vacuum production device according to claim 1.
